(19) United States
(12) Patent Application Publication
(10) Pub. No.: US 2005/0207323 A1
(43) Pub. Date: Sep. 22, 2005

(54) Device for recording data, record carrier and method for recording data

(76) Inventors: Petrus Henricus Cornelius Bentvelsen, Eindhoven (NL); Wilhelmus Fransiscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/511,976

(22) PCT Filed: Apr. 4, 2003
(86) PCT No.: PCT/IB03/01381

§ 371 Date: Oct. 20, 2004

(30) Foreign Application Priority Data
Apr. 25, 2002 (EP) 02076644.0

(51) Int. Cl. G11B 7/24; G11B 5/09

(52) U.S. Cl. 369/275.3; 369/47.15

(57) ABSTRACT

A device and method for recording data on a track (5) of a record carrier (1) are described. The record carrier (1) for use in such a device and method is also described. The record carrier (1) comprises two identical keylockers (7, 8). The keylockers contain encrypted information about the usage rights of the data on the record carrier (1). When these usage rights need to be updated, the keylockers are invalidated and new keylockers are written. Invalidating the old keylockers on a write once record carrier (1) can be done by a laser pulse with a high power level. However, data directly adjacent to the information that is invalidated becomes inaccessible. Therefore, only part of the keylockers (7, 8) is invalidated. This part needs to be an identical part of both keylockers (7, 8) so that the information of the whole keylocker cannot be restored. The distance between the neighboring data and the part of the keylocker that is invalidated is increased by arranging the information of the first keylocker (7) differently from the information of the second keylocker (8) in that the information that is to be invalidated of at least one keylocker is positioned closer to the other keylocker than in a situation in which the information of the keylockers (7, 8) is arranged identically.

The invention relates to a device for recording data on a track of a record carrier, which record carrier comprises a first keylocker which holds information about the data and a second keylocker which holds the same information, which two keylockers are positioned adjacent to each other on the track, the device comprising invalidating means for invalidating the keylockers.

The invention further relates to a record carrier having a track for recording data, the record carrier comprising a first keylocker which holds information about the data and a second keylocker which holds the same information, the two keylockers being positioned adjacent to each other on the track.

The invention also relates to a method of recording data on a track of a record carrier, which record carrier comprises a first keylocker which holds information about the data and a second keylocker which holds the same information, the two keylockers being positioned adjacent to each other on the track, the method comprising a step of invalidating the keylockers.

As copying of data in the form of copyrighted material from one record carrier to an other becomes more and more easy, the need for proper protection of that data becomes greater. An example of a scheme to protect data uses a so-called keylocker. In a keylocker all secrets, for example usage rights, keys, counters, a unique identification of the disc or any information are stored in the keylocker in a tamper-free way. Usage rights may be, for example, the rights to play or copy the data on the record carrier. A keylocker is encrypted with a so-called keylocker key. It is common to have two or more identical copies of the keylocker on the record carrier. If one keylocker is damaged, the other keylocker can be used. The keylockers are commonly placed adjacent to each other.

An example of data that can be protected is music. The keylocker may contain the right to copy the music once. After a copy has been made, the keylocker is updated indicating that no more copy can be made. If the record carrier is a write once record carrier, or if the data is written on the record carrier in a similar way as with a write once record carrier, the updating of the keylocker is done by writing new keylockers and invalidating the old ones. On a write once record carrier, invalidating can be done by damaging the keylockers with a laser pulse having a sufficiently high power level. A problem with this invalidation is that also the data directly adjacent to the keylockers will be damaged or will be inaccessible. The directly adjacent data can be damaged when the data is written interleaved on the record carrier. Interleaved writing means that the data is not written continuously but in blocks, which blocks are written with a spacing between them. That spacing may be, for example, two or three blocks of other data. When data is invalidated, units of data are invalidated that do not coincide with the interleave blocks. Therefore also data adjacent to the keylocker is invalidated. The data directly adjacent to the keylocker may also become inaccessible when the keylocker is invalidated because of the following reason. When a device such as an optical recorder wants to access certain target data on the record carrier, it does not jump directly to the target address of that data, but to a previous address before the target address. This is done because the optical recorder then has time to settle before the target data is read. If the data on the previous address is invalidated, however, the target data is inaccessible.

It is an object of the invention to provide a device and method for recording data which is able to invalidate the keylockers without making the neighboring data inaccessible.

It is also an object of the invention to provide a record carrier which contains keylockers that can be invalidated without making the neighboring data inaccessible.

For this purpose, the device as described in the opening paragraph is characterized in that the invalidating means are able to invalidate the keylockers by invalidating an identical part of the information of the first keylocker and of the second keylocker, the information of the first keylocker being arranged differently from the information of the second keylocker in that the information that is to be invalidated of at least one keylocker is positioned closer to the other keylocker than in a situation in which the information of the keylockers is arranged identically. The record carrier described in the opening paragraph is characterized in that the keylockers can be invalidated by invalidating an identical part of the information of the first keylocker and of the second keylocker, the information of the first keylocker being arranged differently from the information of the second keylocker in that the information that is to be invalidated of at least one keylocker is positioned closer to the other keylocker than in a situation in which the information of the keylockers is arranged identically. The method described in the opening paragraph is characterized in that the step of invalidating the keylockers invalidates the keylockers by invalidating an identical part of the information of the first keylocker and of the second keylocker, the information of the first keylocker being arranged differently from the information of the second keylocker in that the information that is to be invalidated of at least one keylocker is positioned closer to the other keylocker than in a situation in which the information of the keylockers is arranged identically.

It is sufficient to invalidate only a part of the keylocker in order to disable the use of the keylocker. If the same part of all the keylockers is disabled, it is not possible to retrieve the whole keylocker. However, disabling of, for example, the first part of both keylockers will also disable the data preceding the first keylocker. Disabling the first part of the keylockers is preferable, because in practice the space reserved for the keylocker could be greater than the keylocker needs, resulting in the last part of the space reserved for the keylocker being unused. Disabling the last part would have the result that the information of the whole keylocker is still retrievable. If the first part of the first keylocker is arranged closer to the other, adjacent keylocker, then that first part is further away from the preceding data and the preceding data will not be damaged. This ensures a better integrity of the preceding data after invalidation. In an embodiment, the keylocker contains usage rights of the data. These rights may be, for example, the right to copy the data once.

In an embodiment of the recording device, the information that is to be deleted of the first keylocker is directly adjacent to the information that is to be deleted of the second keylocker. This has the advantage that the information that is to be deleted is as far as possible away from the data directly neighboring the keylockers, thereby minimizing the risk of making the neighboring data inaccessible.

In another embodiment, the information contained in the keylockers is divided into sectors. The part of the information that is to be invalidated preferably comprises the last sectors of the first keylocker and the first sectors of the second keylocker.

In a further embodiment, the record carrier comprises more than two keylockers which are adjacent to each other, and the first keylocker and the second keylocker are the two outermost keylockers. Here again the part of the information that is invalidated is further away from the neighboring data. The arrangement of the information of the keylockers between the first and second keylocker is not important in this connection.

These and other aspects of the invention will be apparent from and elucidated further with reference to the embodiments described by way of example in the following description and with reference to the accompanying drawings, in which

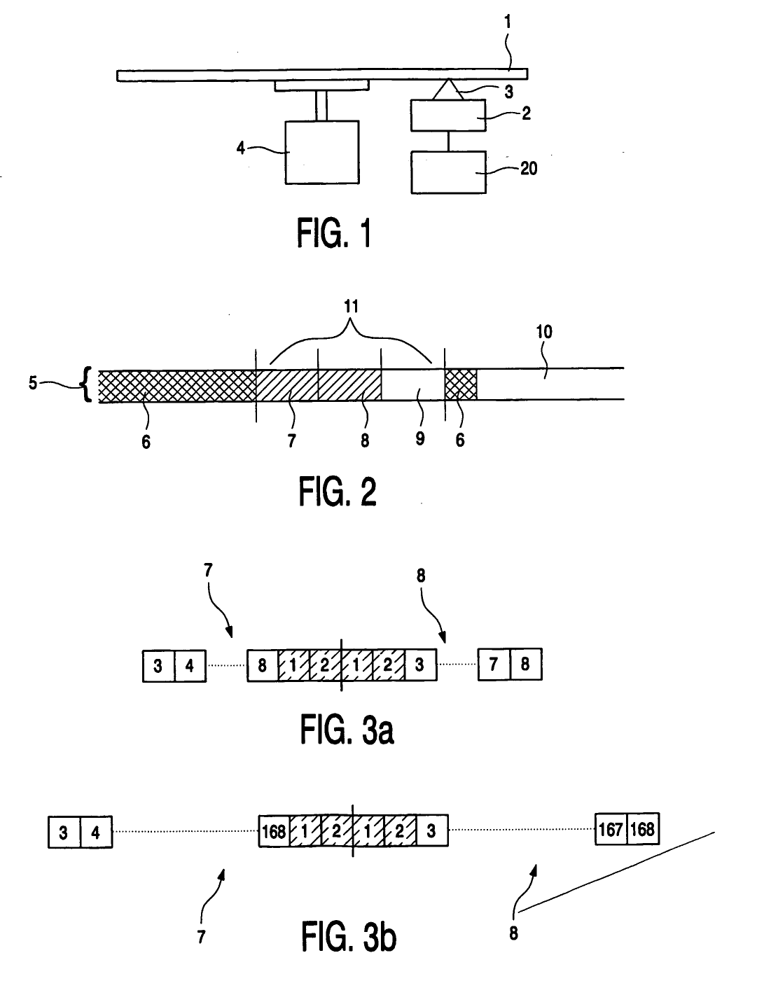

FIG. 1 shows a recording device,

FIG. 2 shows an example of a keylocker area structure,

FIG. 3a shows an example of two identical keylockers,

FIG. 3b shows another example of two identical keylockers,

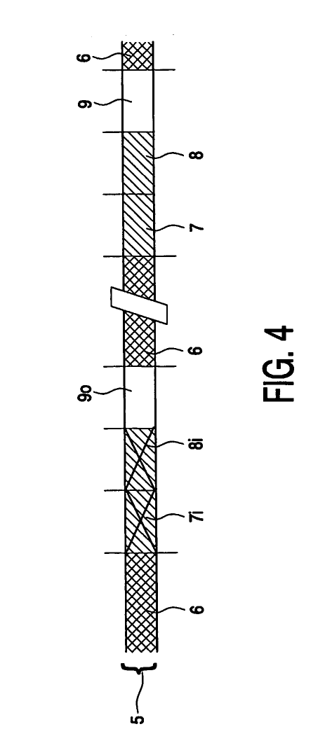

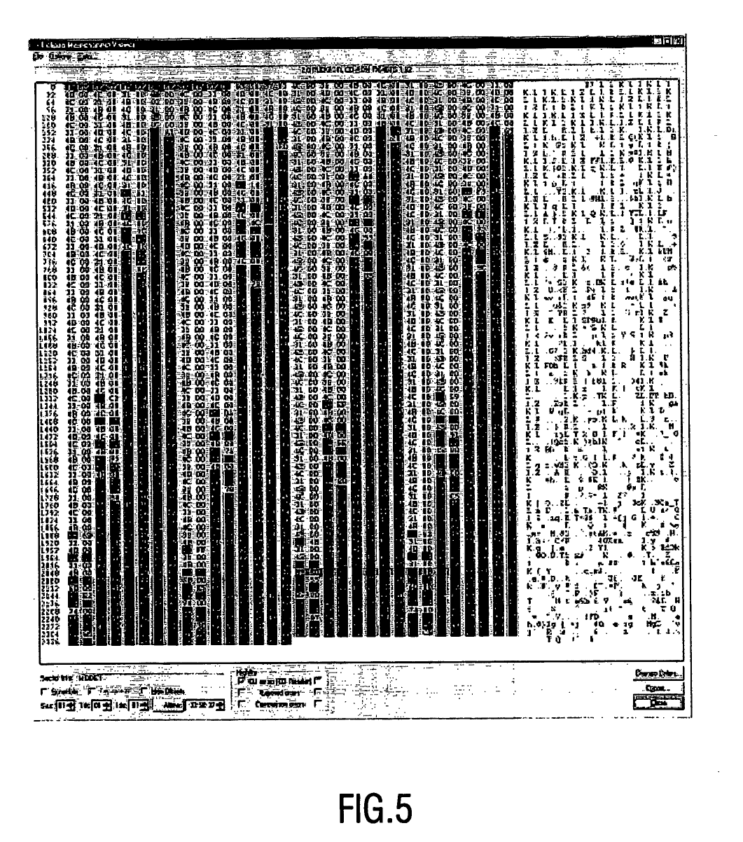

FIG. 4 diagrammatically shows the process of writing new keylockers and invalidating the old keylockers,

FIG. 5 shows an example of a corrupted sector which is directly adjacent to the invalidated sectors.

FIG. 1 shows an embodiment of a recording system having a record carrier 1, rotating means 4, and a transducer 2. The transducer 2 may be, for example, an optical pickup unit. An optical pickup unit emits a radiation beam 3 which is reflected by the record carrier 1. The record carrier 1 in this example contains the data on a track 5 (see FIG. 2), which track 5 may consists of pits that will or will not reflect the radiation beam 3. Physical elements other than pits which result in reflecting or not reflecting the radiation beam 3 may also be used for registering data on the track 5. The reflected radiation beam 3 is converted by the transducer into a signal that is further processed by further processing means in the recording device. The further processing means converts the signal from the transducer 2 into a reproduction signal which may be an audio signal, for example. The recording device also comprises invalidation means 20. The invalidation means 20 are connected to the transducer 2 for invalidating the keylockers. In this embodiment, the record system is also capable of playing back a record carrier 1. In an alternative embodiment, the recording system is capable of recording data on a record carrier 1, but not capable of playing back a record carrier 1.

In FIG. 2, a track 5 which holds a so-called keylocker area 11 is depicted. In this case the keylocker area 11 resides in the program area of the track. The program area is the area where the user data 6 is stored on the track 5. The track 5 in this example also has an unrecorded area 10. The program area thus comprises the user data 6, the keylocker area 11, and the unrecorded area 10. The keylocker area 11 consists of a first keylocker 7, a second keylocker 8, and a further information area 9. The further information area 9 comprises an adaptation layer parameter space ALP, and may comprise an enabling key block EKB and a black list BL. The ALP structure comprises pointers to the keylockers. The EKB is a data structure that is used to communicate a secret cryptographic key to a set of authorized devices or PC applications. The BL is a list containing identifiers of devices or other entities that have been declared invalid.

FIGS. 3a and 3b show two examples of the keylockers 7 and 8 on a record carrier 1 according to the invention. In FIG. 3a, the keylockers 7 and 8 consist of eight sectors each. Each sector in this example contains two kilobytes of information. In FIG. 3b, the keylockers 7 and 8 consist of 168 sectors each. The information contained in the keylockers 7 and 8 is usually encrypted. The encrypted information is stored in the keylockers starting from sector 1 to the last sector. Of course not all sectors need to contain encrypted information. Therefore, when the keylockers need to be invalidated by invalidation of an identical part of the encrypted information of both keylockers, the safest sectors to invalidate are the sectors with the lowest numbers. In this example sectors 1 and 2 are invalidated. The encrypted information of the keylockers shown in FIGS. 3a and 3b are arranged so that sectors 1 and 2 of the first keylocker 7 are directly adjacent to the sectors 1 and 2 of the second keylocker 8. In this way there are six sectors between the invalidated sectors and the neighboring data, which is the maximum number of sectors if two sectors of the keylockers need to be invalidated. In FIG. 3b there are even more sectors between the invalidated sectors and the neighboring data. This ensures the integrity of the neighboring data after invalidation of the keylockers. Of course other sectors and/or an other number of sectors may also be invalidated. The sectors of the first keylocker 7 and the second keylocker 8 that need to be invalidated do not have to be adjacent, but this does have the advantage that there is a maximum number of sectors between the invalidated sectors and the neighboring data. This also has the further advantage that the invalidation process is relatively simple because the sectors can be invalidated with one continuous laser action.

FIG. 4 shows an example of a track 5 which contains a first invalidated keylocker 7i and a second invalidated keylocker 8i. Also the further information area 9o is not used anymore. Two new keylockers 7 and 8 are written on another location on the track 5. A new further information area 9 is also written, because that further information area 9 contains pointers to the new keylockers. If the EKB and the BL need not to be updated, these structures can be maintained in the old further information area 9o. The new further information area 9 then contains pointers to the EKB and BL.

FIG. 5 shows an example of a sector which is directly adjacent to a sector that has been invalidated. The data in the sector depicted in FIG. 5 was not intended to be invalidated or damaged. Since the adjacent sector (not depicted in FIG. 5) was invalidated, however, the data in the sector depicted in FIG. 5 was damaged by accident. The reason for the damaging may be that the data is written interleaved and that invalidating of the keylocker invalidates also neighboring data. The data in the sector is depicted in a hexadecimal representation. The data which is accentuated with the black boxes is corrupted as a consequence of the invalidation of the adjacent sector. This clearly shows that invalidation must not be done directly adjacent to data which must be left intact.

Although the invention has been explained mainly with reference to embodiments of an optical recording device, similar embodiments of recording devices are suitable which have the characteristic that invalidation of data on the record carrier also damages data adjacent to the invalidated data. Also, an optical disc may be used for the record carrier, or other media such as a magnetic disc or tape may be used. It is noted that in this document the verb ‘comprise’ and its derived forms do not exclude the presence of other elements or steps than those listed, and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1. Device for recording data on a track of a record carrier, which record carrier comprises a first keylocker which holds information about the data and a second keylocker which holds the same information, which two keylockers are positioned adjacent to each other on the track, the device comprising invalidating means for invalidating the keylockers, characterized in that the invalidating means are able to invalidate the keylockers by invalidating an identical part of the information of the first keylocker and of the second keylocker, the information of the first keylocker being arranged differently from the information of the second keylocker in that the information that is to be invalidated of at least one keylocker is positioned closer to the other keylocker than in a situation in which the information of the keylockers is arranged identically.

2. Device as claimed in claim 1, characterized in that the information about the data comprises information about the usage rights of the data.

3. Device as claimed in claim 1, characterized in that the information is divided into sectors, and that the information that is to be invalidated consists of one or more sectors for each keylocker.

4. Device as claimed in claim 1, characterized in that the information that is to be deleted of the first keylocker is directly adjacent to the information that is to be deleted of the second keylocker.

5. Device as claimed in claim 3, characterized in that the information that is to be deleted is formed by the last two sectors of the first keylocker and the first two sectors of the second keylocker.

6. Device as claimed in claim 1, characterized in that the record carrier comprises more than two keylockers which are adjacent to each other, and that the first keylocker and the second keylocker are the two outermost keylockers.

7. Record carrier having a track for recording data, the record carrier comprising a first keylocker which holds information about the data and a second keylocker which holds the same information, the two keylockers being positioned adjacent to each other on the track, characterized in that the keylockers can be invalidated through invalidation of an identical part of the information of the first keylocker and of the second keylocker, and the information of the first keylocker is arranged differently from the information of the second keylocker in that the information that is to be invalidated of at least one keylocker is positioned closer to the other keylocker than in a situation in which the information of the keylockers is arranged identically.

8. Record carrier as claimed in claim 7, characterized in that the information about the data comprises information about the usage rights of the data.

9. Record carrier as claimed in claim 7, characterized in that the information is divided into sectors, and that the information that is to be invalidated consists of one or more sectors for each keylocker.

10. Record carrier as claimed in claim 7, characterized in that the information that is to be deleted of the first keylocker is directly adjacent to the information that is to be deleted of the second keylocker.

11. Record carrier as claimed in claim 9, characterized in that the information that is to be deleted is formed by the last two sectors of the first keylocker and the first two sectors of the second keylocker.

12. Record carrier as claimed in claim 7, characterized in that the record carrier comprises more than two keylockers which are adjacent to each other, and that the first keylocker and the second keylocker are the two outermost keylockers.

13. Method of recording data on a track of a record carrier, which record carrier comprises a first keylocker which holds information about the data and a second keylocker which holds the same information, the two keylockers being positioned adjacent to each other on the track, the method comprising a step of invalidating the keylockers, characterized in that the step of invalidating the keylockers invalidates the keylockers by invalidating an identical part of the information of the first keylocker and of the second keylocker, the information of the first keylocker being arranged differently from the information of the second keylocker in that the information that is to be invalidated of at least one keylocker is positioned closer to the other keylocker than in a situation in which the information of the keylockers is arranged identically.

14. Method as claimed in claim 13, characterized in that the information about the data comprises information about the usage rights of the data.

15. Method as claimed in claim 13, characterized in that the information is divided into sectors, and that the information that is to be invalidated consists of one or more sectors for each keylocker.

16. Method as claimed in claim 13, characterized in that the information that is to be deleted of the first keylocker is directly adjacent to the information that is to be deleted of the second keylocker.

17. Method as claimed in claim 15, characterized in that the information that is to be deleted is formed by the last two sectors of the first keylocker and the first two sectors of the second keylocker.

18. Method as claimed in claim 13, characterized in that the record carrier comprises more than two keylockers which are adjacent to each other and that the first keylocker and the second keylocker are the two outermost keylockers.
